(19) United States
(12) Patent Application Publication
(10) Pub. No.: US 2007/0183021 A1
(43) Pub. Date: Aug. 9, 2007

(54) DEVICE WITH ELECTRICALLY ALTERABLE APPEARANCE

(75) Inventor: Shih-Chieh HUANG, Taipei City (TW)

Correspondence Address: QUINTERO LAW OFFICE, PC, 2210 MAIN STREET, SUITE 200, SANTA MONICA, CA, 90405, US

(73) Assignee: LITE-ON TECHNOLOGY CORPORATION, TAIPEI (TW)

(21) Appl. No.: 11/671,863

(22) Filed: Feb. 6, 2007

(30) Foreign Application Priority Data
Feb. 8, 2006 (TW) TW95104207

(51) Int. Cl. G02B 26/00

(52) U.S. Cl. 359/296

(57) ABSTRACT

The invention discloses a device with electrically alterable appearance including a shell having a non-display region, with a thin-film display disposed thereon to alter the appearance of the electronic device by electrically writing operation. The thin-film display maintains the present appearance of the electronic device without power supply.

### BACKGROUND OF THE INVENTION

1. Field of the Invention

The invention relates to a device with electrically alterable appearance and more particularly to a device using a thin-film display to provide an electrically alterable appearance.

2. Description of the Related Art

Electronic devices can be classified according to whether they provide a display region or not, the display region output via technology such as cathode ray tubes, liquid crystals or plasma. Electronic devices with a display region, for example, can comprise mobile sets, electronic watches, electronic calculators, computer displays, televisions, and others. Electronic devices without any display regions, for example, can comprise computer mice, keyboards, refrigerators, electronic fans, and others.

FIGS. 1A-1C respectively show a mobile set, an electronic watch, a computer display, having display region(s) 11 and non-display region(s) 12. FIGS. 1D-1F respectively show a keyboard, a refrigerator, a computer mouse, none having display region(s) and having only non-display region(s) 12.

To alter the appearance of the non-display regions of electronic devices, traditional methods include: replacing the shell of the electronic device body, leading to extra costs for shells and limited to predetermined appearance and disposing a light source emitting various colors inside the electronic device, although on light color is changed, limiting the variation in appearance and requiring additional power.

Electronic ink is a novel material technology that can comprise a thin film printed on plastic, glass, paper and other material.

Eink Inc. of USA demonstrated an electric paper supporting multicolored electronic ink in a “Society for Information Display” exhibition in 2002. Current products applying electronic ink include a watch named “Future Now”, co-developed by Eink Inc. and Seiko Epson Co. The electronic ink is applied on the display region of the watch to show time information. Sony Electronics Inc. in Japan also manufactured the first display employing electronic ink technology in the world.

Electronic ink mainly comprises millions of microcapsules. FIGS. 2A and 2B are cross sections of a microcapsule of prototype electronic ink capable of emitting black and white colors under different electronic fields. As FIGS. 2A and 2B show, the microcapsule 21 is located between a transparent top electrode 22 and a bottom electrode 23. The microcapsule 21 comprises transparent fluid 24, positively-charged white particles 25 and negatively-charged black particles 26. As shown in FIG. 2A, when a negative electric field is applied, the white particles 25 move to the top of the microcapsule 21, forming a white spot, while the black particles 26 move to the bottom of the microcapsule 21, becoming invisible. The microcapsule 21 thus emits white color. Conversely, as shown in FIG. 2B, when a negative electric field is applied, the black particles 26 move to the top and form a dark spot, while the white particles move to the bottom of the microcapsules 21, becoming invisible. The microcapsule 21 thus emits black color.

Illumination principle, explained using prototype electronic ink as an example, can further use red, green and blue microcapsules to display other colors. Researchers in Canada have developed a new multicolor electronic ink named “Photonic Ink” using diffraction mechanics of light to illuminate different colors. Photonic Ink comprises many SiO₂ balls with a diameter of about 300 nm stacked on each other. When light transmits through Photonic Ink, it reflects and interferes back and forth, generating light of specific color. Further, the SiO₂ balls are covered with conductive polymer colloid. The polymer colloid expands when infused in solvents and contracts when removed therefrom. The color of the Photonic Ink is changed by adjusting infusion degree of the polymer colloid in solvents via different imposed voltages to alter the distance between the SiO₂ balls.

### BRIEF SUMMARY OF THE INVENTION

The invention discloses electronic devices with a shell on which is disposed a thin-film display, capable of altering the appearance depending on user direction. The thin-film display requires no power to sustain the exterior display that has been written.

The invention provides a device with electrically alterable appearance comprising a shell having a non-display region, with a thin-film display disposed thereon to alter the appearance of the electronic device by electrically writing operation. The thin-film display maintains the present appearance of the electronic device without power supply.

The invention also provides a device with electrically alterable appearance comprising a thin-film display disposed thereof to alter the appearance of the electronic device by electrically writing operation. The thin-film display maintains the present appearance of the electronic device without power supply.

In an embodiment, electronic ink is employed as the thin-film device.

### BRIEF DESCRIPTION OF THE DRAWINGS

The invention can be more fully understood by reading the subsequent detailed description and examples with references made to the accompanying drawings, wherein:

FIGS. 1A-1C respectively show a mobile set, an electric watch, a computer display, illustrating display regions and non-display regions thereof;

FIG. 1D-1F respectively show a keyboard, a refrigerator, a computer mouse, illustrating non-display regions thereof;

FIGS. 2A and 2B are cross sections of a microcapsule in a prototype electronic ink emitting black and white colors under different electronic fields;

FIG. 3 shows a device with electrically alterable appearance in accordance with an embodiment of the invention using a mobile set as an example;

FIG. 4 is a block diagram of a device with electrically alterable appearance in accordance with an embodiment of the invention; and

FIGS. 5A-5C respectively show a painting, a manual toy car and a flower vase with an artificial flower, illustrating non-screen-regions thereof.

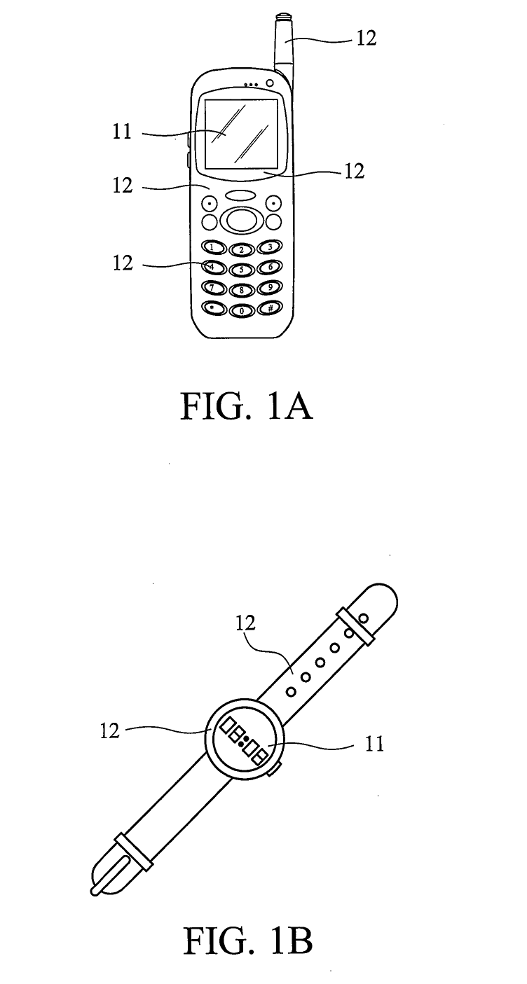

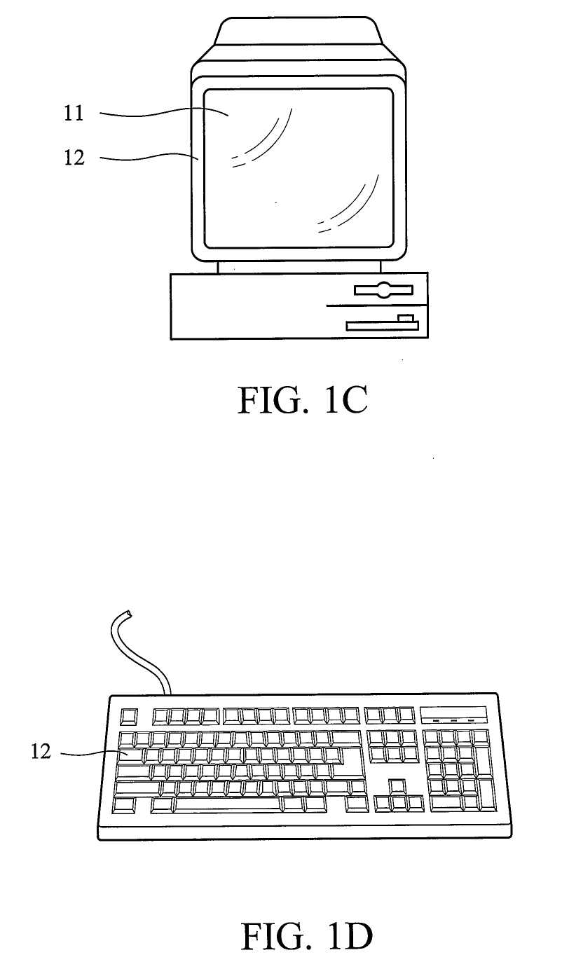

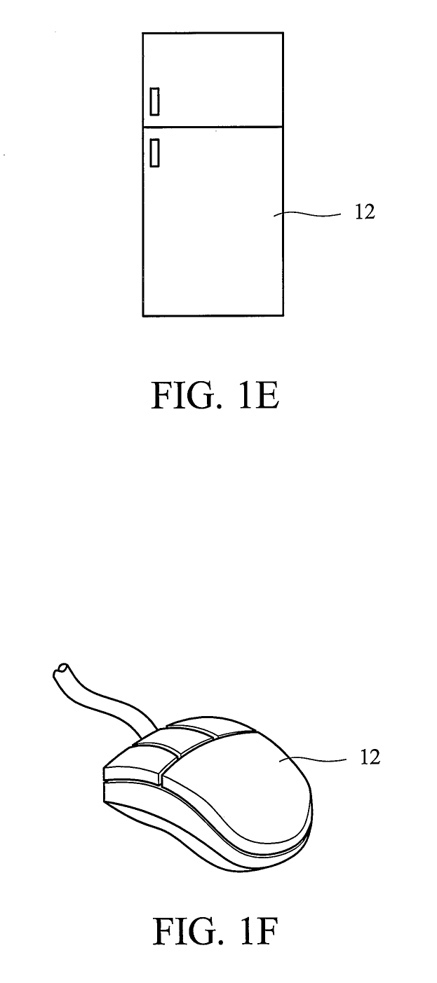

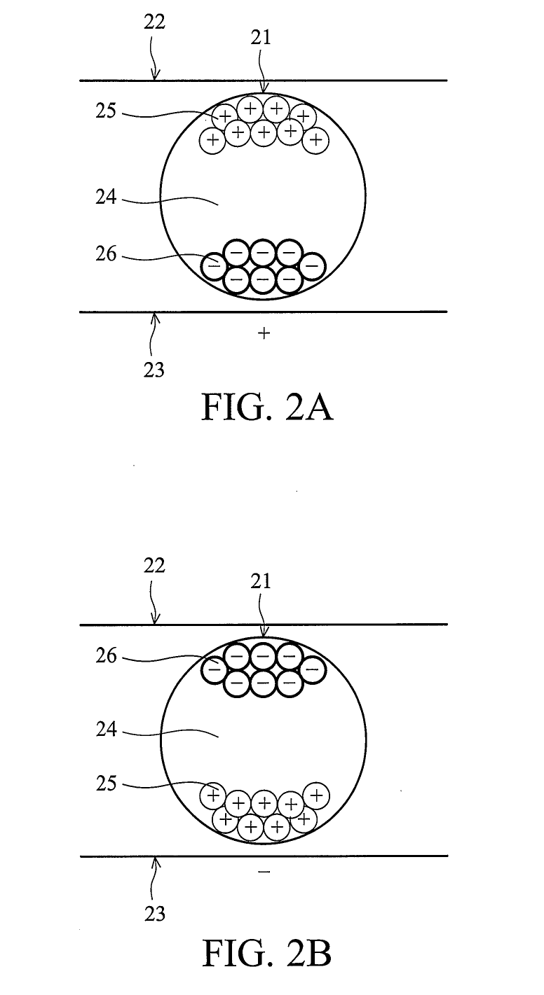

### DETAILED DESCRIPTION OF THE INVENTION

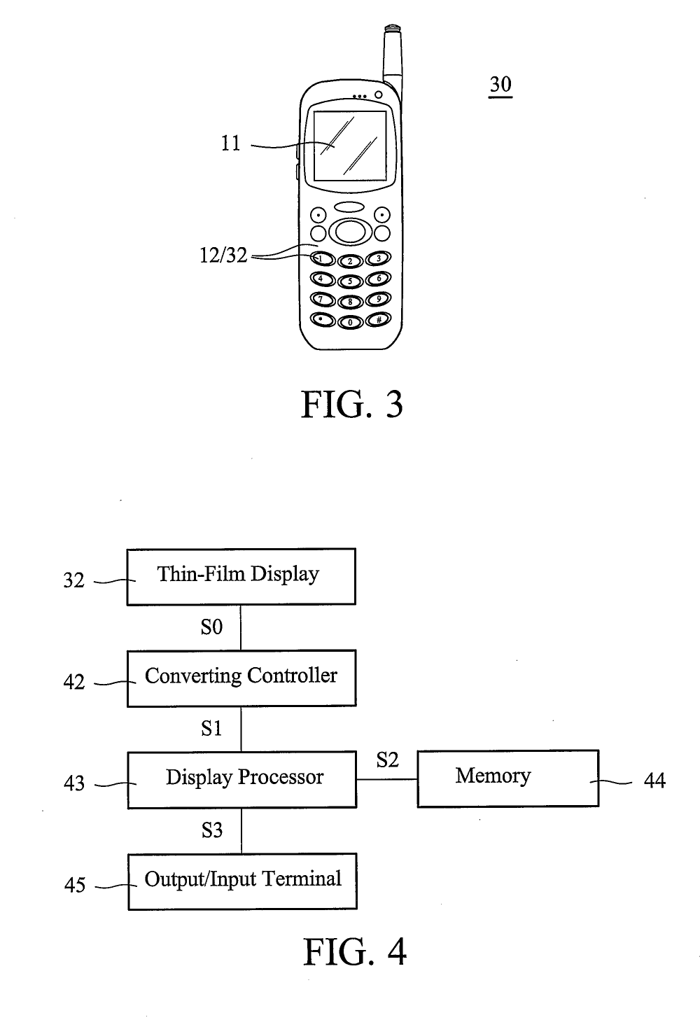

FIG. 3 shows a device with electrically alterable appearance of the invention using a mobile set as an example. As shown, the mobile set 30 has a shell comprising a display region 11 comprising a liquid crystal display, and non-display regions 12 comprising push-buttons and a shell near the liquid crystal display and push-button. A thin-film display 32 is disposed on the non-display region 12. The thin-film display 32 displays various pictures, patterns and/or colors by electrically writing display data into the thin-film display 32. The thin-film display 32 requires no power to sustain the exterior display of the mobile set. It is noted that the mobile set 30 is used as an example, and the thin-film display can be disposed on any device.

Preferably, the thin-film display 32 meets requirements of low thickness, high flexibility, and low power consumption. A preferable example of the thin-film display 32 is electronic ink described earlier. Electronic ink is applied on non-display regions conventionally to display information such as characters or video. However, one of the advantages of electronic ink is it can be printed or applied on numerous materials. Further, it uses light reflection mechanics and thus requires no backlight source, such that once display data is written, no power is required to sustain the written exterior display. Accordingly, electronic ink can be applied as a thin-film display.

FIG. 4 shows a block diagram of a device with electrically alterable appearance in accordance with an embodiment of the invention. As shown, the device with electrically alterable appearance comprises a thin-film display 32, a converting controller 42, a display processor 43, a memory 44, and an input/output terminal 45.

The converting controller 42 is connected to the thin-film display 32. When a writing operation is performed on the thin-film display 32, such that the thin-film display 32 displays a desired pattern or picture, the converting controller 42 receives first display data S1, converting S1 to a signal S0 required by the thin-film display, and finally transmitting the signal S0 to the thin-film display 32 such that the thin-film display 32 displays the desired pattern or picture. The converting controller 32 also administrates the thin-film display 32 such that it operates normally. It is noted that the converting controller 42 can be designed as a removable component, that is, connected with the thin-film display 32 during use but removed when not. Moreover, if the device such as a mobile set has a component having similar functions, the converting controller 42 can be integrated with the component rather than disposed as an independent component.

The display processor 43 administrates transmission of display data from the output/input terminal 45 or memory 44 to the converting controller 42. As shown, the display processor 43 receives third display data S3 from the output/input terminal 45 or second display data S2 from the memory 44, and provides the first display data S1 to the converting controller 42. The display processor 43 processes and converts the third or second display data S3/S2 to the first display data S1 of another data form, or processes and outputs the first display data S1 directly without processing and conversion.

The display processor 43 further administrates the transmission of display data between the output/input terminal 45 and the memory 44. As shown, the display processor 43 receives the thirds display data S3 from the output/input terminal 45 and outputs the second display data S2 to the memory 44, or conversely, receives the second, display data S2 from the memory 44 and outputs the third display data S3 to the input/output data 45. Similarly, after the display processor 43 receives the second (third) display data S2 (S3), it processes and converts the second (third) display data S2/S3 to the third (third) display data. S3 (S2) of another data form, or processes and outputs the third (third) display data S3 (S2) directly without processing and conversion.

It is noted that the display controller 43 can also be employed as a removable component, connected with the converting controller 42 during use but removed when not. Moreover, if the device such as a mobile set has a component having similar functions, the display controller 43 can be integrated with the component rather than disposed as an independent component.

The memory 44 stores display data for user selection, and is controlled by the display controller 43 to provide the second display data S2 stored therein to the display processor 43, or stores the second display data S2 received from the display processor 43. As mentioned, the second display data S2 received by the display controller is obtained from the third display data S3 processed and converted or directly provided by the output/input terminal.

It is noted that the memory 44 can also be employed as a removable component, that is, connected with the display processor 43 during use but removed when not. Moreover, if the device such as a mobile set has a component having similar functions, the memory 44 can be integrated with the component rather than disposed as an independent component. Further, the memory 44 is not necessary and can be excluded, wherein first display data S1 is provided by only the third display data S3.

The output/input terminal 45 is connected to the display processor 43 such that the display processor 43 is able to receive the third display data S3 from an external device such as a personal computer, or conversely, such that the external device is able to receive the third display data S2 output by the display processor 43. As such, various display data stored in the memory 44 can be output via the output/input terminal 45. Also, display data can be displayed by the thin-film display 32 or stored in the memory 44 via the output/input terminal 45.

It is noted that the output/input terminal 45 can also be employed as a removable component, that is, connected with the display processor 43 during use but removed when not. Moreover, if the device such as a mobile set has a component having similar functions, the output/input terminal 45 can be integrated with the component rather than disposed as an independent component. Further, the output/input terminal 45 is not imperative and can be excluded, wherein first display data S1 is provided only by the second display data S2.

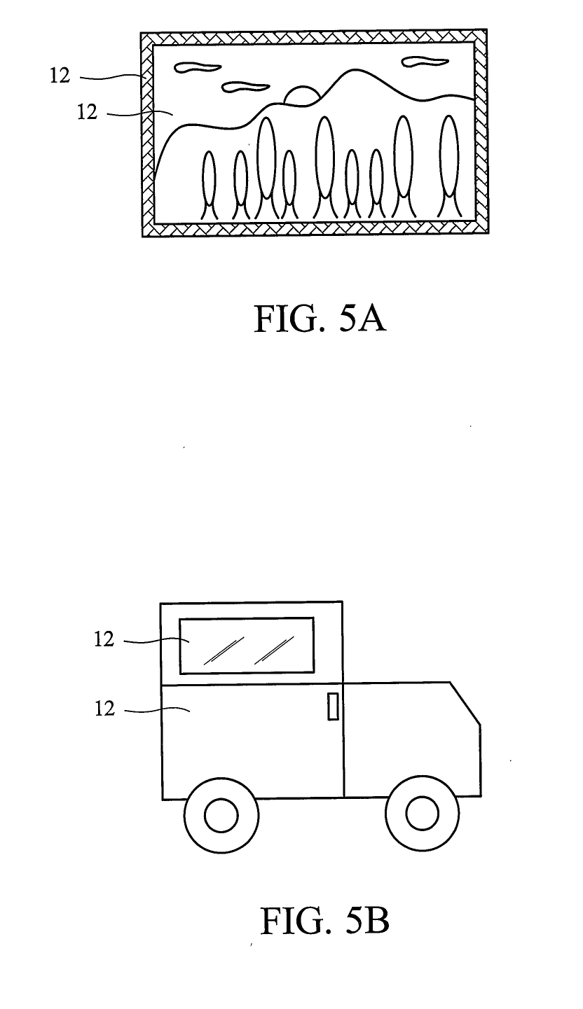

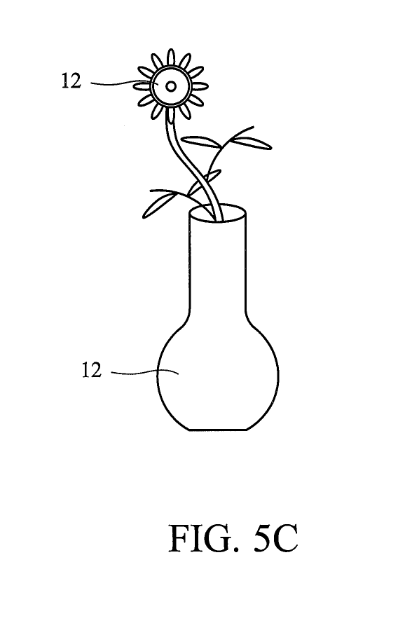

The invention can be applied not only to electronic devices but also to any device. FIGS. 5A-5C respectively show a painting, a manual toy car and a flower vase with an artificial flower. The painting frame and even the painting within the painting frame in FIG. 5, the entire surface of the toy car in FIG. 5B, and the surface of the flower vase and even the artificial flower, all are none-display regions. A thin-film display can be disposed on part or all of the non-display regions, where an embodiment of a block diagram of the device can also be referred to FIG. 4, and when display data is written into the thin-film display, the appearance of the device changes accordingly.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A device with electrically alterable appearance comprising:
a shell having a non-display region, with a thin-film display disposed thereon to alter the appearance of the device by electrically writing operation, wherein the thin-film display maintains the present appearance of the electronic device without power supply.

2. The device with electrically alterable appearance of claim 1, wherein the thin-film display is electronic ink shaped into a thin film and disposed on the non-display region.

3. The device with electrically alterable appearance of claim 1, further comprising a converting controller to control the thin-film display, receiving and converting first display data to a signal required by the thin-film display and transmitting the signal to the thin-film display.

4. The device with electrically alterable appearance of claim 3, further comprising a display processor to control the converting controller, receiving display data, processing and converting the display data to the first display data or outputting directly the display data as the first display data, and providing the first display data to the converting controller.

5. The device with electrically alterable appearance of claim 4, further comprising a memory controlled by the display processor, receiving second display data from the display processor and providing the second display data as the display data.

6. The device with electrically alterable appearance of claim 4, further comprising an output/input terminal connected to the display processor via which the display processor receives third display data as the display data or outputs the third display data.

7. The device with electrically alterable appearance of claim 5, further comprising an output/input terminal connected to the display processor via which the display processor receives third display data as the display data or outputs the third display data.

8. The device with electrically alterable appearance of claim 7, wherein the display processor processes and converts the third display data provided by the output/input terminal to the second display data or outputs the third display data provided by the output/input terminal directly as the second display data, and then provides the second display data to the memory as the display data; and wherein the display processor processes and converts the second display data provided by the memory to the third display data or outputs directly the second display data provided by the memory as the third display data, and then provides the third display data to the output/input terminal.

9. A device with electrically alterable appearance comprising:
a thin-film display disposed on non-display region thereof to alter the appearance of the device by electrically writing operation, wherein the thin-film display maintains the present appearance of the electronic device without power supply.

10. The device with electrically alterable appearance of claim 9, wherein the thin-film display is electronic ink shaped into a thin film and disposed on the non-display region.

11. The device with electrically alterable appearance of claim 9, further comprising a converting controller to control the thin-film display, receiving and converting first display data to a signal required by the thin-film display and transmitting the signal to the thin-film display.

12. The device with electrically alterable appearance of claim 11, further comprising a display processor to control the converting controller, receiving display data, processing and converting the display data to the first display data or outputting directly the display data as the first display data, and providing the first display data to the converting controller.

13. The device with electrically alterable appearance of claim 12, further comprising a memory controlled by the display processor, receiving second display data from the display processor and providing the second display data as the display data.

14. The device with electrically alterable appearance of claim 12, further comprising an output/input terminal connected to the display processor via which the display processor receives third display data as the display data or outputs the third display data.

15. The device with electrically alterable appearance of claim 13, further comprising an output/input terminal connected to the display processor via which the display processor receives third display data as the display data or outputs the third display data.

16. The device with electrically alterable appearance of claim 15, wherein the display processor processes and converts the third display data provided by the output/input terminal to the second display data or outputs the third display data provided by the output/input terminal directly as the second display data, and then provides the second display data to the memory as the display data; and wherein the display processor processes and converts the second display data provided by the memory to the third display data or outputs directly the second display data provided by the memory as the third display data, and then provides the third display data to the output/input terminal.
